(19) United States
(12) Patent Application Publication
(10) Pub. No.: US 2005/0204133 A1
(43) Pub. Date: Sep. 15, 2005

(54) Reduction in unwanted e-mail (spam) through the use of portable unique utilization of public key infrastructure (PKI)

(75) Inventor: Robert Clarence LaLonde, Augusta, GA (US)

Correspondence Address: ROBERT C. LALONDE, 3118 EXETER ROAD, AUGUSTA, GA, 30909, US

(73) Assignee: Robert Clarence LaLonde, Augusta, GA (US)

(21) Appl. No.: 10/708,514

(22) Filed: Mar. 9, 2004

(51) Int. Cl. H04L 9/00

(52) U.S. Cl. 713/168

(57) ABSTRACT

An enhanced email system that will reduce unwanted email or allow for categorization of wanted versus unwanted by use of sender identification. Senders employ an email module to sign email or possibly paste it in themselves, allowing for portable identity. Modified email servers and clients look for these signatures and either deny or sort based on them. A security server or servers supply keys with expirations upon which the signatures are based. Users in good standing, receive updated keys in email. A forwarding system allows uniquely identified senders to target uniquely identified receivers, irregardless of email/ISP service of choice or opportunity.

### SUMMARY OF INVENTION

The primary weakness of email is its indiscriminate nature. It allows anyone to send a message to anyone else, without invitation or proof of identity.

All users of an enhanced electronic mail system will be identified via a unique public key.

Electronic mail servers and clients (including HTML web server based email clients) can be enhanced to automatically include this signature and sort incoming email based on the presence and validity of the signature.

This serves the purpose of unique identification of the source of every email. This identification is portable.

This also thwarts a common practice among the purveyors of unwanted email, namely source spoofing.

### DETAILED DESCRIPTION

A PKI server (or servers) will be setup to serve as a third party certifier for each sender and receiver. Each end user will provide proof of identity to receive their first key, replace a lost key, or possibly to install on a new machine.

Keys will only be valid for a specific period of time. Assuming the decision to remove a user has not occurred due to misuse of the system, reported stolen keys, inactive account, request for closure, etc, a new key will be emailed to the end user.

When a new key is emailed, it will either be encrypted based on the old key and sent prior to the expiration of the old key, or it will be sent in a way that old key plus the email generate the new key.

An Email server (or servers) will be updated to only accept incoming mail with a valid signature or route to different folders based on the signature. Similarly, an email client can accept, reject, or route to folders based on signatures.

A signature is based on the key of the sender and the contents of the email and/or time. This results in a signature that is different each time, even though each time it is based on the same key. This prevents theft of a signature.

The portability of the unique key is beneficial in that one can send from any email address. For the system to be truly useful, members need to be able to reach each other no matter what email address is used. A system of email forwards will support this universal addressability. These email forwards can be maintained by the users or automatically, from the last email address used by the user.

The system of forwards does not prevent a central email account.

The use of digital signatures neither requires nor precludes the additional encryption.

This invention neither requires nor precludes other methods of controlling unwanted email, including but not limited to filters, domain authentication and email postage initiatives.

This system in no way prevents mass mailings. In some cases, such as discussion groups, news letters, and marketing for desired product, mass mailings are desired. No promise of conduct is required. Those that misuse the system can be dealt with by key expiration. No data related to number of recipients need be added to the email.

Usage of email forwarding system and any central system can be monitored for usage patterns, including misuse.

In the event of sever misuse that can not wait for a key expiration, a “black list” can be supported. This would be a special message or messages sent to all connected servers and possibly end users to block all email from a specific user.

1. Use of unique keys maintained by third party to end users for classification of email.

2. Specific email server and client plug-ins to be developed to support portability.

3. System of email forwards to support universal portability.

4. Method of automatic renewal of email user keys through email update.
